(19) United States
(12) Patent Application Publication
(10) Pub. No.: US 2026/0147251 A1
(43) Pub. Date: May 28, 2026

(54) Lens-Assisted Beam Steering Apparatus

(71) Applicant: The Charles Stark Draper Laboratory, Inc., Cambridge, MA (US)

(72) Inventors: Lucas D. Benney, Brighton, MA (US); Steven J. Spector, Lexington, MA (US)

(21) Appl. No.: 19/398,312

(22) Filed: Nov. 24, 2025

Related U.S. Application Data
(60) Provisional application No. 63/725,653, filed on Nov. 27, 2024.

(51) Int. Cl. G02F 1/295

(52) U.S. Cl. CPC G02F 1/2955; G02F 2203/24

(57) ABSTRACT

An optical beam steering apparatus includes an array of optical elements. Each optical element includes a lens, a switchable array of optical emitters configured to emit light into the lens, and a phase-shifting element configured to control a phase of the light emitted by the optical emitters. A controller is configured to control the array of optical elements to emit a beam of light in a predetermined direction. The controlling includes coarsely adjusting a direction of the beam of light, including, for at least some optical elements of the array of optical elements, configuring the optical element's switchable array of optical emitters to emit light into the optical element's lens according to the predetermined direction. The controlling also includes finely adjusting the direction of the beam of light, including configuring the phase-shifting elements of the optical elements to control a phase relationship between the light emitted by the optical elements according to the predetermined direction.

### CROSS-REFERENCES TO RELATED APPLICATIONS

This application claims the benefit of U.S. Provisional Application No. 63/725,653 filed Nov. 27, 2024, the entire contents of which are hereby incorporated herein by reference.

### BACKGROUND OF THE INVENTION

Optical beam steering systems are important for applications that require precise directional control of optical signals, including free-space optical communications between satellites and ground stations, Light Detection and Ranging (LiDAR) systems for three-dimensional mapping, and directed energy systems. These applications often require wide beam steering angles, fast response times, and high pointing accuracy.

### SUMMARY OF THE INVENTION

Some conventional beam steering approaches use mechanical systems (e.g., gimbaled optical transmitters) to steer optical signals, but mechanical systems may be too bulky for certain applications (e.g., satellite applications) and may be limited in their ability to track fast-moving objects. Optical phased arrays are one example of a non-mechanical beam steering technology that addresses size and tracking speed limitations of mechanical systems, but are typically only capable of steering a beam over a modest range of angles or require wavelength steering. Lens-assisted beam steering is another example of a non-mechanical beam steering technology that addresses the tracking speed limitations of mechanical systems, but for many applications can require a lens that is too large to be practical.

Aspects described herein relate to a non-mechanical beam steering optical transmitter that combines optical phased array and lens-assisted beam steering techniques in a small package to achieve fast and precise steering over a wide range of angles.

In a general aspect, an optical beam steering apparatus includes an array of optical elements. Each optical element includes a lens, a switchable array of optical emitters configured to emit light into the lens, and a phase-shifting element configured to control a phase of the light emitted by the optical emitters. A controller is configured to control the array of optical elements to emit a beam of light in a predetermined direction. The controlling includes coarsely adjusting a direction of the beam of light, including, for at least some optical elements of the array of optical elements, configuring the optical element's switchable array of optical emitters to emit light into the optical element's lens according to the predetermined direction. The controlling also includes finely adjusting the direction of the beam of light, including configuring the phase-shifting elements of the optical elements to control a phase relationship between the light emitted by the optical elements according to the predetermined direction.

Aspects may include one or more of the following features.

At least some optical emitters of the array of optical emitters may be grating emitters. The optical emitters of the switchable array of optical emitters may be disposed at known locations relative to the lens. Coarsely adjusting the direction of the beam of light may include simulating motion of a source of the light emitted into the lens by changing a configuration of the switchable array of optical emitters. Each optical emitter in the switchable array of optical emitters may include a grating emitter with design parameters selected based on a position of the optical emitter relative to the lens, where the design parameters are configured to direct light from the optical emitter toward a center of the lens.

Finely adjusting the direction of the beam of light may include using optical beamforming techniques. Finely adjusting the direction of the beam may include moving the lens of at least some of the optical elements relative to the switchable optical emitters of the optical elements.

The optical elements of the array of optical elements may be disposed at known locations relative to each other. Coarsely adjusting the direction of the beam of light may include, for each optical element, switching at least some optical emitters to an on state and switching at least some other optical emitters to an off state.

The switchable array of optical emitters may be implemented as an optical circuit on a MEMS device. The optical circuit may include a waveguide connecting the switchable array of optical emitters to a light source. The waveguide may be connected to the light source through the phase-shifting element. The phase-shifting element of at least one optical element may include a thermo-optic phase-shifter.

The apparatus may further include a number of optical waveguides, each optical waveguide connecting at least one optical emitter of a switchable array to a light source, where the optical waveguides have path lengths configured to provide substantially equal total optical path length from the light source to each optical emitter across all optical elements, enabling broadband operation. Each optical waveguide may include a compensating delay section having a length predetermined based on a position of a corresponding optical emitter, where the compensating delay section is positioned between a switching network and the corresponding optical emitter.

Lenses of the optical elements may be joined to form a unitary structure. The beam steering apparatus may be part of a satellite communication system. The apparatus may be configured to emit optical power exceeding 100W distributed across the array of optical elements. The optical elements of the array of optical elements may be arranged in one of: a hexagonal array pattern or a square array pattern.

In another general aspect, a method for steering an optical beam includes controlling an array of optical elements to emit a beam of light in a predetermined direction. Each optical element includes a lens, a switchable array of optical emitters configured to emit light into the lens, and a phase-shifting element configured to control a phase of the light emitted by the optical emitters. The controlling includes coarsely adjusting a direction of the beam of light, including, for at least some optical elements of the array of optical elements, configuring the optical element's switchable array of optical emitters to emit light into the optical element's lens according to the predetermined direction. The controlling also includes finely adjusting the direction of the beam of light, including configuring the phase-shifting elements of the optical elements to control a phase relationship between the light emitted by optical elements according to the predetermined direction.

Among other advantages, the lens-assisted optical phased array transmitter described herein addresses multiple limitations of conventional beam steering approaches. Compared to conventional optical phased arrays, the present system reduces the number of phase-controlled elements by, for example, at least an order of magnitude while achieving comparable or better steering range.

Compared to conventional lens-assisted beam steering systems, the system described herein enables smaller lens sizes (e.g., on the order of 1 mm diameter rather than centimeters) and can scale to high optical powers (e.g., exceeding 100 W). That is, the architecture of the optical transmitter enables scaling to high optical power levels exceeding 100 W while maintaining a compact form factor. Unlike some conventional lens-assisted beam steering systems where all optical power is emitted from a single small point at the focal plane, the optical transmitter described herein distributes the optical power across multiple optical elements, each handling a fractional part of the total power. The distributed architecture advantageously reduces thermal loading per element, minimizes nonlinear optical effects, and enables the use of standard photonic integrated circuit fabrication processes.

The combined effect of coarse steering (e.g., using switchable emission positions) and fine steering (e.g., using phase control) enables the system to advantageously achieve wide-angle steering comparable to mechanical systems while still having fast steering speeds comparable to pure optical phased arrays, all while maintaining a compact size suitable for space-based applications (e.g., in nanosatellites).

Some aspects advantageously address the narrow bandwidth limitations often associated with conventional optical phased arrays, accomplishing broadband operation through path-length matching of optical waveguides. Doing so advantageously enables operation across a broad optical spectrum without having to use wavelength-dependent steering.

Some aspects advantageously improve free-space optical communications, where the system enables rapid tracking of moving satellites, aircraft, or ground terminals without requiring mechanical gimbals. The high-power capability of the optical transmitter enables long-distance links between satellites or between ground terminals and satellites. The compact form factor of the optical transmitter advantageously makes the system well suited for small satellite platforms such as CubeSats and nanosatellites where volume and mass are restricted.

Other features and advantages of the invention are apparent from the following description, and from the claims.

### BRIEF DESCRIPTION OF THE DRAWINGS

FIG. 1 is a satellite communication system.

FIG. 2 is an optical transmitter.

FIG. 3 is a detailed view of optical elements.

FIG. 4 is a first configuration of the optical transmitter during operation.

FIG. 5 shows a transition to an updated beam direction.

FIG. 6 is a second configuration of the optical transmitter during operation.

FIG. 7 is a third configuration of the optical transmitter during operation.

FIG. 8 is a broad optical band optical transmitter.

FIG. 9 shows the effect of smooth steering.

FIG. 10 is a flat star tracker.

### DETAILED DESCRIPTION

### 1 Overview

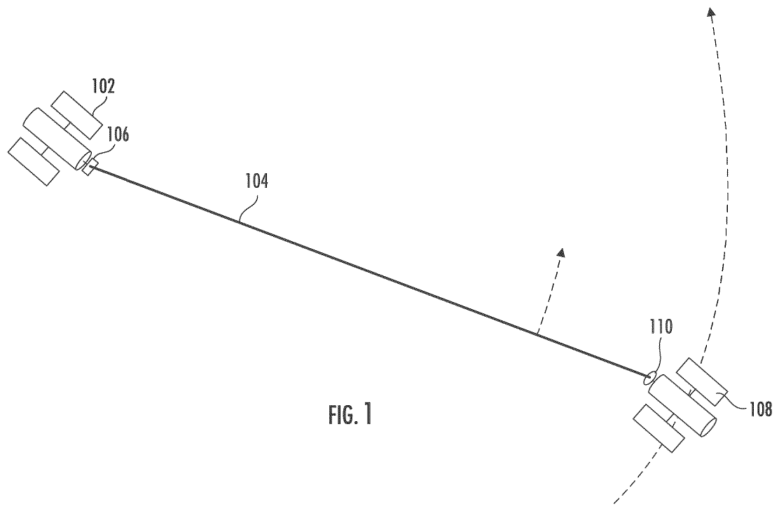

Referring to FIG. 1, two satellites are communicating using free-space optical communications, with a first satellite 102 emitting an optical signal 104 as a beam of light using an optical transmitter 106 and a second satellite 108 receiving the optical signal using an optical receiver 110. As the satellites change position, the optical transmitter 106 steers the optical signal 104 to track the optical receiver 110 and maintain communication.

As is described in greater detail below, in some examples the optical transmitter 106 is a non-mechanical beam steering optical transmitter that combines optical phased array and lens-assisted beam steering techniques in a small package to achieve fast and precise steering over a wide range of angles.

### 2 Lens-Assisted Optical Phased Array Transmitter

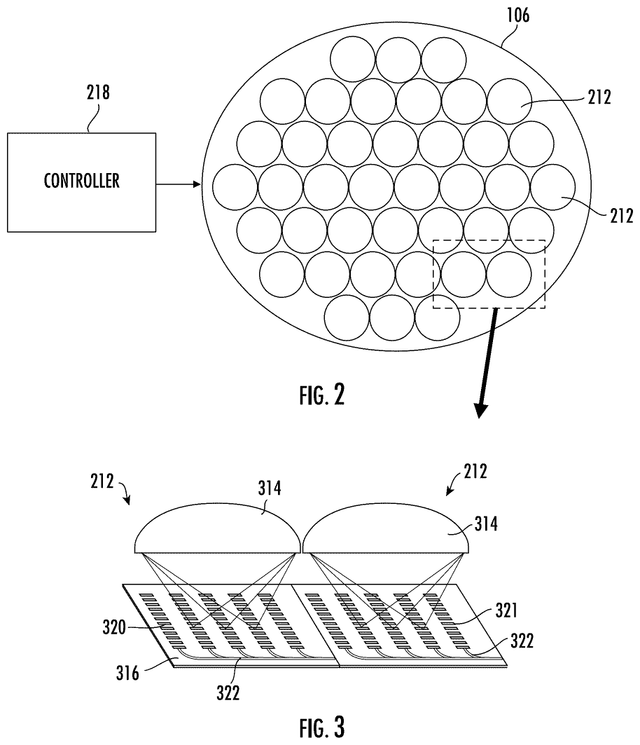

Referring to FIGS. 2 and 3, in one example, the optical transmitter 106 includes an array of optical elements 212 (e.g., in a hexagonal arrangement as shown in FIG. 2). Each optical element 212 includes a lens 314 and an array of switchable optical emitters 316. In some examples, the array of switchable optical emitters 316 is a MEMS grating switch with a number of switchable optical emitters 320 connected to one or more optical waveguides 322, as described in U.S. Pat. No. 10,684,420, the entire contents of which are incorporated herein by reference.

As is described in greater detail below, a controller 218 controls (and coordinates) the optical elements 212 to steer the beam using a combination of a coarse steering procedure and a fine steering procedure. The coarse steering procedure leverages the fact that moving a light source relative to a lens can induce large changes in the direction of the light emitted from the lens. The fine steering procedure leverages the fact that a direction of emission of the beam of light emitted by the optical transmitter 106 can be steered in small amounts by adjusting the relative phase differences between light emitted from the optical elements 212 (i.e., beamforming).

### 3 Example Of Operation

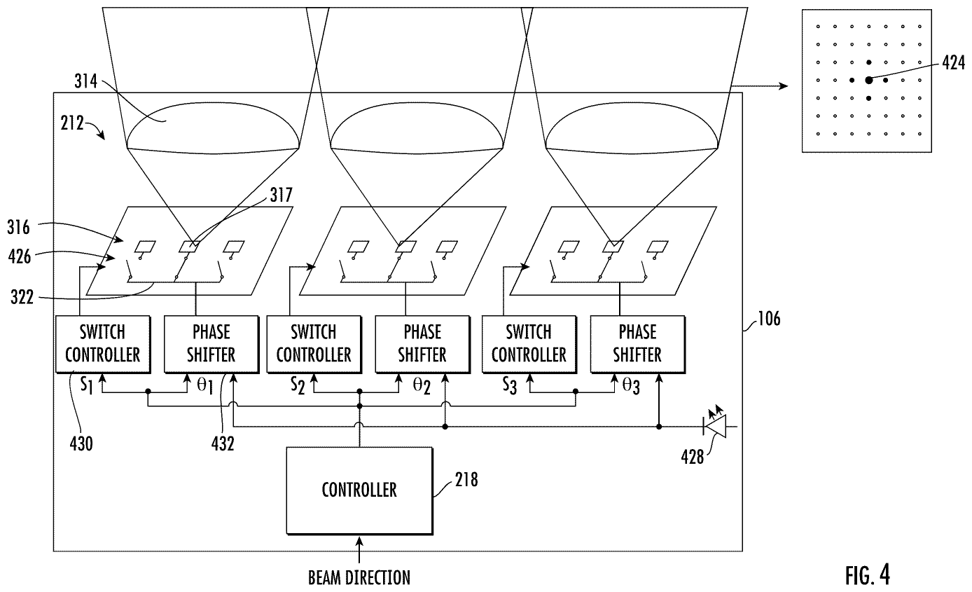

Referring to FIG. 4, in one example of operation, the controller 218 has already configured three optical elements 212 of the optical transmitter 106 to emit a beam of light according to a first “Beam Direction.” In the case of FIG. 4, the emitted beam has most of its optical power focused in one, central order 424.

As is noted above, each of the optical elements 212 has a lens 314 and an array of switchable optical emitters 316 configured to emit light into the lens. A switching network 426 is configurable to switch individual optical emitters into and out of communication with an optical waveguide 322 connected to an optical source 428. An optical emitter that is in communication with the optical waveguide 322 emits light into the lens 314.

In some examples, each optical element 212 also has a switch controller 430 and a phase-shifter 432 (sometimes referred to as a phase-shifting element). The switch controller 430 is configured to receive a switch configuration (e.g., Sn) from the controller 218 and configure the switching network 426 of the optical element 212 based on the switch configuration. The phase-shifter 432 receives an optical signal from the optical source 428 and a phase shift instruction (e.g., On) from the controller 218 and shifts a phase of the optical signal (relative to the phase of the optical signal in the other optical elements) before it is fed into the optical element's waveguide 322. In some examples, the phase-shifter 432 is implemented as a thermo-optic phase-shifter that modules the refractive index of a waveguide section through localized heating. In some examples, the thermo-optic phase-shifter has low optical loss (e.g., less than 0.5 dB), is compact, and has modest power requirements. The switching speed of the thermos-optic phase-shifters are generally in the range of tens of kilohertz.

In FIG. 4, the controller 218 has configured the switching networks 426 of each of the three optical elements 212 such that only a central optical emitter 317 of the optical element emits light into the lens 314. The controller 218 has also configured the phase-shifters 432 such that there is no relative phase difference between the optical signals fed into the waveguides 322 of the optical elements. As a result, the emitted beam (a combination of the light emitted from all the optical elements 212) has most of its optical power focused in one central order 424.

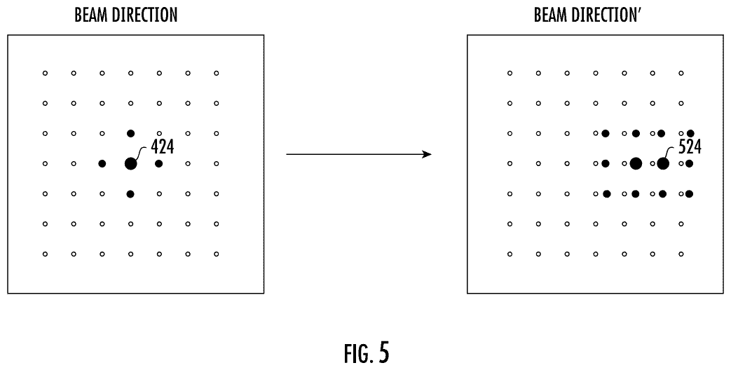

Referring to FIG. 5, one example operation of the optical transmitter 106 includes steering the beam from the central order 424 associated with the “Beam Direction” to an updated direction 524 (i.e., “Beam Direction′ ”), slightly more than two orders to the right of the central order 424. This example operation is informative because moving between the two beam directions requires both coarse and fine beam steering. In the following two sections, coarse and fine beam steering are described serially, but it is noted that they may occur in any order, serially or at least partially simultaneously.

### 3.1 Coarse Beam Steering

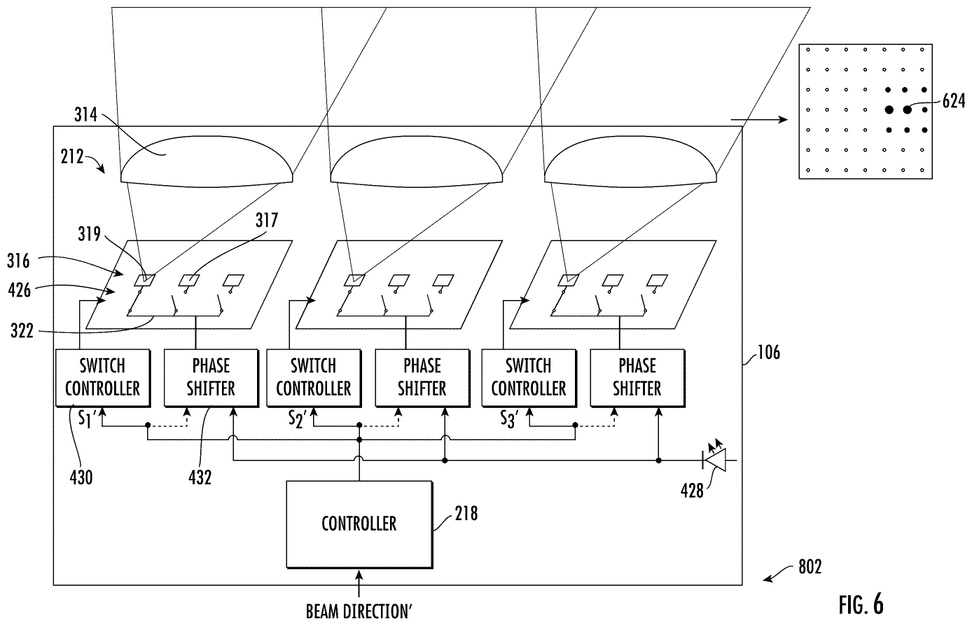

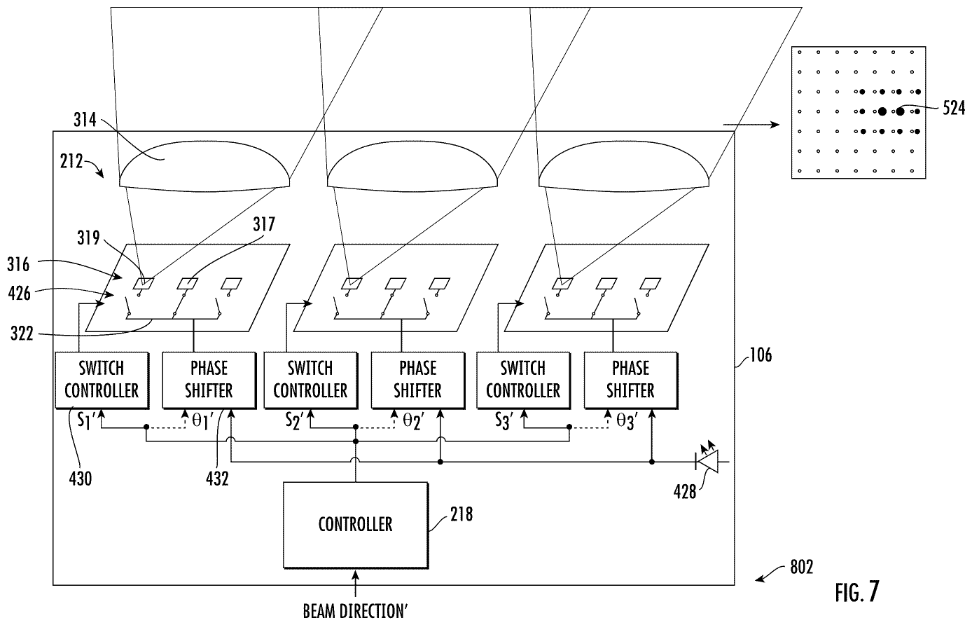

Referring to FIG. 6, the controller 218 receives the updated beam direction (i.e., “Beam Direction′”) as input and determines configurations for the switching networks 426 of the optical elements 212 to enable the appropriate optical emitters 317 such that a beam emitted by the optical transmitter is as close as possible to the updated beam direction.

For example, in FIG. 6, achieving the updated beam direction requires steering the beam from its central location in FIG. 4 toward the right. The controller 218 transmits switching instructions, Sₙ′ to the switch controllers 430, causing the central optical emitter 317 of the optical elements to be switched off and the leftmost optical emitter 319 to be switched on. As a result, the source of light being emitted into the lenses has moved to the left, causing the beam direction to shift right. In this case, the beam is now at a coarse beam direction 624, focused exactly two orders to the right of the central order 424, and still needs to be moved with a finer granularity to achieve the updated beam direction. Note that this is due to the optical emitters 316 being located at discrete locations under the lenses 314, meaning that a continuous range of steering cannot be achieved by coarse steering alone.

### 3.2 Fine Beam Steering

Referring to FIG. 7, the controller 218 also determines a phase relationship between the light emitted from the optical elements 212 that further steers the beam emitted from the transmitter from its coarse beam direction 624 exactly two orders to the right of the central order 424 to its desired, updated beam direction 524.

Based on the determined phase relationship, the controller 218 sends a phase shift instruction, θₙ to the phase-shifter 432 of each optical element. Each phase-shifter 432 receives the phase shift instruction, θₙ, and the optical signal from the optical source 428 and phase shifts the optical signal according to θₙ before it is fed into the waveguide 322 of the optical element 212.

As is described above, at each optical element 212, the shifted optical signal is emitted into the lens 314 from the leftmost optical emitter 319. The relative phase shift between the light emitted from the optical elements 212 causes the light to combine in a way that forms a beam that is finely shifted from the coarse beam direction to the updated beam direction, 524 slightly more than two orders to the right of the central order 424.

### 4 Alternatives

### 4.1 Grating Emitters

In some examples, the array of switchable optical emitters 316 is specifically designed based on its position relative to the lens 314 to, for example, ensure coupling efficiency between the emitters and the lens. In some examples, the grating design is predetermined based on known geometric relationships between the emitters and the lens centers. The emitters in FIG. 6 are disposed at different locations beneath the lens and are configured to direct light toward the center of the lens in a way that compensates for the emitter not being directly beneath the lens. The emitters can be configured according to grating parameters such as directionality, period, etch depth, etc.

### 4.2 Broadband Operation

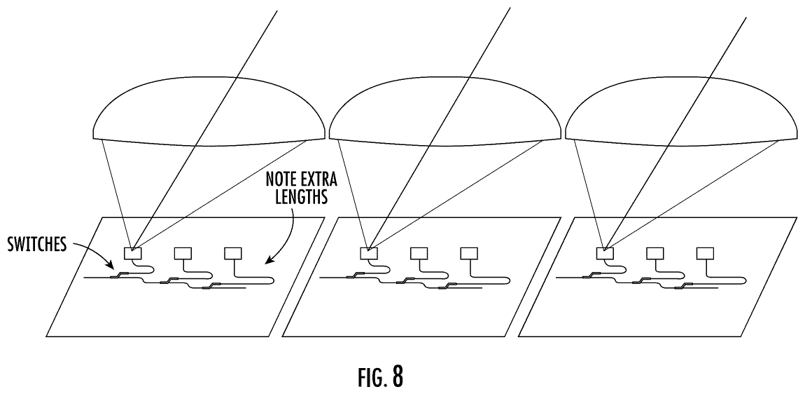

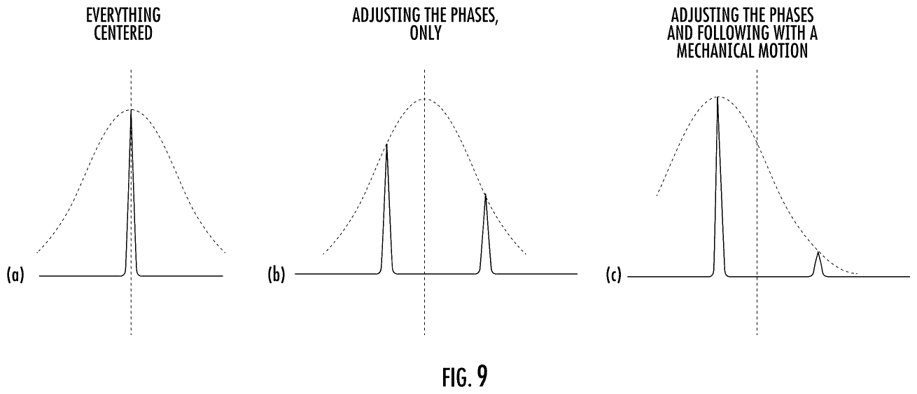

Referring to FIG. 8, in some examples, the waveguides connecting the optical emitters to the optical source have their path lengths configured such that the transmitter operates over a broad optical band. For example, in some conventional optical phased arrays, grating lobe orders occur at angles where the optical path difference between adjacent emitters equals an integer number of wavelengths. With different path lengths, the systems exhibit wavelength-dependent behavior that limits the operational bandwidth of the systems.

To enable broadband operation, the path lengths are matched. This exploits the fact that each grating emitter is used to point at a specific grating lobe order. Path length delays are inserted for each grating in the optical elements such that the total optical path length from the optical source to each emitter is substantially the same, eliminating or reducing any wavelength-dependent behavior.

### 4.3 Tilting and Micro-Motions

In other examples, a limitation of using the switchable emitter arrays described above for order selection is that it may not be possible to place the emission sources close enough to access every grating lobe order. Each order is separated at the focal plane at approximately the diffraction limited spot width, corresponding to the spacing between lens elements. For some designs this spacing is a few microns at the focal plane, which may require the emitters to be spaced more closely together than can be practically fabricated.

To overcome this limitation, another fine steering method can be used. In some examples, a liquid crystal (LC) device is positioned in front of (or behind) each lens element and configured to tilt the phase front of the light passing through the lens. For example, the liquid crystal device can be electronically controlled to introduce a controlled phase gradient across the aperture of each lens element, effectively steering the beam in small increments.

Another fine steering method uses additional “micro-motions” of the lens array relative to the emitters. Micro-motions are fine movements (e.g., translations) of the entire lens array in a controlled manner relative to the emitter chip (where the displacement of the lens array is typically less than one emitter spacing). In some examples, micro-motions allow access to all orders when optical emitters would be too far apart to access every order. In some examples, the micro-motions are accomplished using, for example, piezoelectric actuators, MEMS actuators, or other suitable positioning systems.

In further examples, there may be a loss of efficiency as the beam is steered between orders. For example, the lens forms a transmission envelope that the phase array steers within. With fine motions, it is possible to move the envelope along with the beam from the phase array, so that the beam from the phase array is always centered in the envelope.

Whether implemented through liquid crystal phase tilting for mechanical micro-motion, the magnitude of the required motion or phase tilting is generally at least an order of magnitude less than if the system was designed to use one of these methods for the entire steering. The smaller range of motion makes it much simpler to engineer, enables systems with much faster steering, and increases reliability compared to systems that rely on a single steering mechanism for the full steering range.

In FIG. 9, illustrates the efficiency benefit of combining coarse and fine steering with the fine steering mechanism tracking the phase-array steering. The plot labeled a) shows the beam emitted when the components of the optical elements are centered (i.e., the phase is flat, and the source and lens are on-axis). The plot labeled b) shows the resulting beam shift when the phase is adjusted to steer the beam. Because the window created by each lens element is not shifted, the power in the main beam decreases, while the power in the adjacent beam increases. The plot labeled c) shows that, by shifting the window (e.g., by smoothly steering the lens array by mechanical motion or LC phase tilting), the coarse steering can follow the fine steering from the optical phase array and effects shown in plot b) can be avoided.

The addition of smooth steering (either by mechanical motion or LC phase tilting) may also enable better performance at all locations. As described previously, the use of a lens array creates a window that the optical phase array will steer within. If the emission from each lens element is fixed, then as the optical phase array steers the beam, the beam power is no longer centered in this window. By finely adjusting the emission/lens position (or effectively doing this through a phase tilt), the coarse steering (i.e., order selection) can follow the fine steering (from the optical phase array), and keep the coarse steering centered on the fine location, as is shown in FIG. 9.

### 4.4 Alternative Applications

The transmitter is described above in the context of free-space optical communications. However, the transmitter is usable in other contexts such as LiDAR systems and other applications where optical power needs to be directed at a target. In LiDAR systems, the fast steering capability can enable rapid scanning for three-dimensional mapping applications, while the distributed aperture enables high pulse energies for extended range. In some examples, optical power exceeding e.g., 100 W can be achieved.

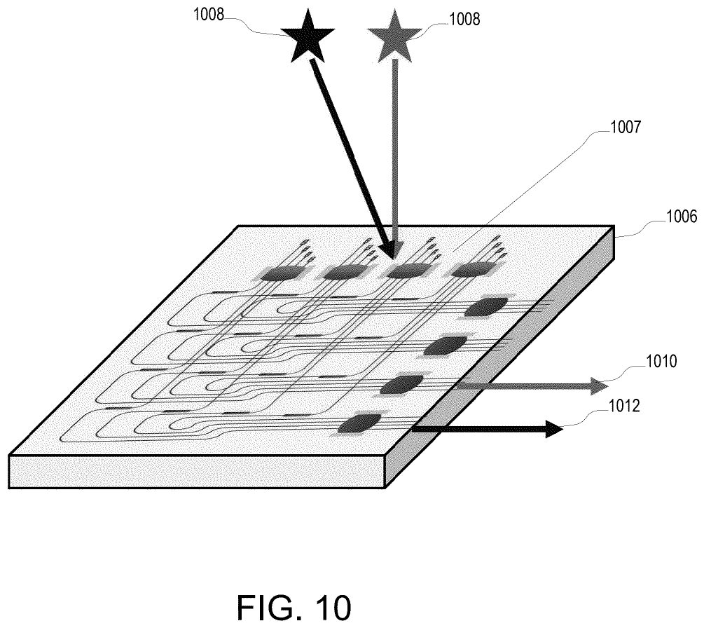

Referring to FIG. 10, in some examples, the lens-assisted phased array described herein can operate in a receiving mode rather than as an emitter. For example, the lens-assisted phased array can be used as a flat start tracker 1006. The flat star tracker 1006 includes an array of optical elements configured to receive incoming light rather than emit it. A photonic integrated circuit 1007 includes an array of optical detectors positioned beneath a lens array. Incoming starlight from multiple stars 1008 at different angular positions is received by the lens array and detected across the detector array.

The photonic circuit 1007 processes the received light to determine angular positions of the stars, with separate image data 1010, 1012 corresponding to each detected star being output (e.g., to a downstream processor or sensor). In some examples the photonic circuit 1007 has a path-matched phased array architecture that enable broadband imaging across a wide optical spectrum. In some examples, the photonic circuit 1007 is implemented as a multi-layer Rotman lens photonic circuit that provides beamforming functionality in a planar configuration. By replacing the single large lens of a conventional start tracker with a flat photonic chip, the apparatus achieves volume reduction (e.g., to less than 10 mm total thickness, making it suitable for integration into nanosatellites and other volume and mass-constrained platforms where traditional telescope based star trackers would not fit.

### 4.5 Miscellaneous Alternatives

The example described above is illustrative, but it should be noted that the operation of the transmitter can be more complex. For example, the switching network may enable multiple emitters for a particular optical element to achieve more complex steering effects. Furthermore, not all optical elements will necessarily have the same set of emitters enabled. The same goes for the phase-shifting of the light at the optical elements. There situations where individual emitters at a single optical element may have different phase shifts.

In some examples, the optical emitters are grating emitters that are configured to direct light different directions based on their location such that the light emitted by the emitters is centered on the lens, regardless of emission location. By switching which emitter is used to emit light into a lens, motion of the source of emitted light can be simulated.

In general, the individual lenses are very small (e.g., with an approximately 1 mm diameter). In some examples, the individual lenses are joined to form a unitary lens array.

In the example described above, the array of optical elements 212 was arranged in a hexagonal geometric configuration. However, it should be noted that other geometric configurations may be used. For example, the optical elements may be arranged in a square array, a rectangular array, or other pattern. In general, different geometric configurations can be chosen to suit different application requirements and aperture size and shape.

It should be noted that this method allows for other components to be integrated into a photonic integrated circuit including the switchable array of optical emitters. For example, a phase-shifter (either MEMS or thermo-optic) or an optical amplifier could be integrated into the photonic integrated circuit.

In the example described above, the phase-shifter 432 is a thermo-optic phase-shifter. However, it is noted that other technologies can be used to implement the phase-shifter. For example, when faster steering speeds are required (MHz range), an electro-optic phase-shifter that modules the refractive index through an applied electric field can be used. In other examples, MEMS-based phase-shifters with movable waveguide sections or reflective elements can be used to adjust optical phase length. In yet other examples, the phase-shifter can be implemented as an acousto-optic phase-shifter that uses acoustic waves to modulate the refractive index. In general, different types of phase-shifters have different characteristics such as switching speed, optical loss, power consumption, size, and complexity. As such the application often dictates what type of phase-shifter is used.

### 5 Implementations

The computational resource allocation approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. An optical beam steering apparatus comprising:
an array of optical elements, each optical element including
a lens,
a switchable array of optical emitters configured to emit light into the lens, and
a phase-shifting element configured to control a phase of the light emitted by the optical emitters;
a controller configured to control the array of optical elements to emit a beam of light
in a predetermined direction, the controlling including
coarsely adjusting a direction of the beam of light, including, for at least some optical elements of the array of optical elements, configuring the optical element's switchable array of optical emitters to emit light into the optical element's lens according to the predetermined direction,
finely adjusting the direction of the beam of light, including configuring the phase-shifting elements of the optical elements to control a phase relationship between the light emitted by the optical elements according to the predetermined direction.

2. The apparatus of claim 1, wherein at least some optical emitters of the array of optical emitters are grating emitters.

3. The apparatus of claim 1 wherein the optical emitters of the switchable array of optical emitters are disposed at known locations relative to the lens.

4. The apparatus of claim 3 wherein coarsely adjusting the direction of the beam of light includes simulating motion of a source of the light emitted into the lens by changing a configuration of the switchable array of optical emitters.

5. The apparatus of claim 1 wherein finely adjusting the direction of the beam of light includes using optical beamforming techniques.

6. The apparatus of claim 1 wherein finely adjusting the direction of the beam includes moving the lens of at least some of the optical elements relative to the switchable optical emitters of the optical elements.

7. The apparatus of claim 1 wherein the optical elements of the array of optical elements are disposed at known locations relative to each other.

8. The apparatus of claim 1 wherein coarsely adjusting the direction of the beam of light includes, for each optical element, switching at least some optical emitters to an on state and switching at least some other optical emitters to an off state.

9. The apparatus of claim 1 wherein the switchable array of optical emitters is implemented as an optical circuit on a MEMS device.

10. The apparatus of claim 9 wherein the optical circuit includes a waveguide connecting the switchable array of optical emitters to a light source.

11. The apparatus of claim 10 wherein the waveguide is connected to the light source through the phase-shifting element.

12. The apparatus of claim 1, wherein the phase-shifting element of at least one optical element comprises a thermo-optic phase-shifter.

13. The apparatus of claim 1, wherein each optical emitter in the switchable array of optical emitters includes a grating emitter with design parameters selected based on a position of the optical emitter relative to the lens, wherein the design parameters are configured to direct light from the optical emitter toward a center of the lens.

14. The apparatus of claim 1, further comprising a plurality of optical waveguides, each optical waveguide connecting at least one optical emitter of a switchable array to a light source, wherein the optical waveguides have path lengths configured to provide substantially equal total optical path length from the light source to each optical emitter across all optical elements, enabling broadband operation.

15. The apparatus of claim 14, wherein each optical waveguide includes a compensating delay section having a length predetermined based on a position of a corresponding optical emitter, wherein the compensating delay section is positioned between a switching network and the corresponding optical emitter.

16. The apparatus of claim 1 wherein lenses of the optical elements are joined to form a unitary structure.

17. The apparatus of claim 1 wherein the beam steering apparatus is part of a satellite communication system.

18. The apparatus of claim 1, wherein the apparatus is configured to emit optical power exceeding 100 W distributed across the array of optical elements.

19. The apparatus of claim 1, wherein the optical elements of the array of optical elements are arranged in one of: a hexagonal array pattern or a square array pattern.

20. A method for steering an optical beam, the method including:
controlling an array of optical elements to emit a beam of light in a predetermined direction, each optical element including a lens, a switchable array of optical emitters configured to emit light into the lens, and a phase-shifting element configured to control a phase of the light emitted by the optical emitters the controlling including,
coarsely adjusting a direction of the beam of light, including, for at least some optical elements of the array of optical elements, configuring the optical element's switchable array of optical emitters to emit light into the optical element's lens according to the predetermined direction,
finely adjusting the direction of the beam of light, including configuring the phase-shifting elements of the optical elements to control a phase relationship between the light emitted by optical elements according to the predetermined direction.
